(19) United States
(12) Patent Application Publication
(10) Pub. No.: US 2010/0128770 A1
(43) Pub. Date: May 27, 2010

(54) Measuring Delay in a Network Segment and/or through a Network Communications Device

(76) Inventor: Adrian Stanciu, Bucharest (RO)

Correspondence Address: SoCAL IP LAW GROUP LLP, 310 N. WESTLAKE BLVD. STE 120, WESTLAKE VILLAGE, CA, 91362, US

(21) Appl. No.: 12/276,220

(22) Filed: Nov. 21, 2008

(51) Int. Cl. H04B 17/00

(52) U.S. Cl. 375/228

(57) ABSTRACT

Measuring delay in a network segment and/or through a network device is disclosed. A method includes a sender preparing a real-time transport protocol with a transmit timestamp based on the time received from a remote, well-known time server, and a receiver computing a one way delay based on a receive time obtained from a remote, well-known time server and the transmit timestamp. A method in a single system includes a sender preparing a real-time transport protocol with a transmit timestamp based on the system, and a receiver computing a one way delay based on a receive time obtained from the system and the transmit timestamp. The method may be performed on one or more network cards and in one or more network testing systems, and may be implemented by one or more computing devices.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND

1. Field

This disclosure relates to network communications, network device testing, network testing and network traffic analysis.

2. Related Art

Networks such as the Internet carry a variety of data communicated using and through a variety of network devices including servers, routers, hubs, switches, and other devices. Before placing a network into use, the network, including the network devices, network media, network segments and network applications included therein, may be tested to ensure successful operation. Network devices and applications may be tested, for example, to ensure that they function as intended, comply with supported protocols, and can withstand anticipated traffic demands. Such testing may also be performed on already deployed network devices, network segments and network applications.

To assist with the construction, installation and maintenance of networks, network applications and network devices, networks may be augmented with network analyzing devices, network conformance systems, network monitoring devices, and network traffic generators, all which are referred to herein as network testing systems. The network testing systems may allow for analyzing the performance of networks, network applications and network devices by capturing, modifying, analyzing and/or sending network communications. The amount of delay between nodes or other devices in a network may be evaluated by network testing systems. The network testing systems may be used to evaluate how well a network device or network segment handles streaming media and voice communications.

### DESCRIPTION OF THE DRAWINGS

FIG. 1 is a block diagram of a first environment in which measuring delay may be implemented.

FIG. 2 is a block diagram of a network card in which measuring delay may be implemented.

FIG. 3 is a block diagram of a second environment in which measuring delay may be implemented.

FIG. 4 is a diagram of a packet used in measuring delay.

FIG. 5 is a flow chart of actions taken by a sender of a packet implementing a method of measuring delay.

FIG. 6 is a flow chart of actions taken by a recipient of a packet implementing a method of measuring delay.

### DETAILED DESCRIPTION

Throughout this description, the embodiments and examples shown should be considered as exemplars, rather than limitations on the apparatus and methods described.

A System

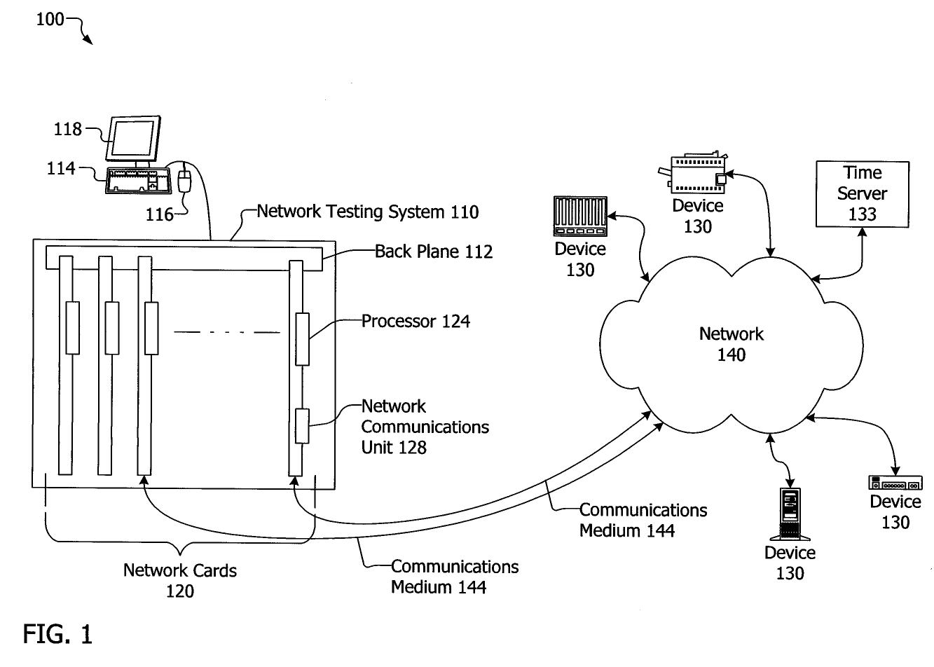

FIG. 1 is a block diagram of a first environment in which measuring delay may be implemented. The first environment 100 shows a first embodiment of the systems and methods for measuring delay described herein. The environment 100 includes network testing system 110 coupled via a network card 120 to a network 140 over a communications medium 144. The network testing system 110 may include or be one or more of a performance analyzer, a conformance validation system, a network analyzer, a packet blaster, a network management system, a combination of these, and/or others. The network testing system 110 may be used to evaluate or measure characteristics and performance of a network communication medium, a network communications device or system, including the throughput of network traffic, the number of dropped packets, jitter, packet delay, and many others. Such testing may be used to evaluate the Mean Opinion Score (MOS) or R-value score of a voice transmission, a video quality score or rating, a broadband quality score, or other similar media transmission score for a communication over a network or portion thereof and/or through a network communications device. The network testing system may be used to evaluate the performance of servers, network communications devices such as, for example, routers, gateways, load sharers, and others, as well as network applications and other software.

The network testing system 110 may be in the form of a chassis or card rack, as shown in FIG. 1, or may be an integrated unit. Alternatively, the network testing system may comprise a number of separate units such as two or more chassis cooperating to provide network analysis, network conformance testing, and other tasks. The chassis of the network testing system 110 may include one or more network cards 120 and a back plane 112. The network cards 120 may be coupled with back plane 112. One or more network cards 120 may be included in network testing system 110. The network cards 120 may be permanently installed in the network testing system 110, may be removable, or may be a combination thereof.

The network testing system 110 and/or one or more of the network cards 120 may include an operating system such as, for example, versions of Linux, Unix and Microsoft Windows.

Network card 120 is coupled with network 140 via a communications medium 144. Although two connections over communications medium 144 are shown, each of the network cards 120 may be connected with network 140 over a communications medium. In one embodiment, the network cards may have two or more connections each over a communications medium with the network 140 and/or with multiple networks. The communications medium may be, for example, wire lines such as an Ethernet cable, fibre optic cable, and coaxial cable, and may be wireless.

The network testing system 110 and the network cards 120 may support one or more well known higher level communications standards or protocols such as, for example, one or more versions of the User Datagram Protocol (UDP), Transmission Control Protocol (TCP), Internet Protocol (IP), Internet Control Message Protocol (ICMP), Internet Group Management Protocol (IGMP), Session Initiation Protocol (SIP), Hypertext Transfer Protocol (HTTP), address resolution protocol (ARP), reverse address resolution protocol (RARP), file transfer protocol (FTP), Real-time Transport Protocol (RTP), Simple Mail Transfer Protocol (SMTP); may support one or more well known lower level communications standards or protocols such as, for example, the 10 and/or 40 Gigabit Ethernet standards, the Fibre Channel standards, one or more varieties of the IEEE 802 Ethernet standards, Asynchronous Transfer Mode (ATM), X.25, Integrated Services Digital Network (ISDN), token ring, frame relay, Point to Point Protocol (PPP), Fiber Distributed Data Interface (FDDI), Universal Serial Bus (USB), IEEE 1394 (also known as i.link® and Firewire®); may support proprietary protocols; and may support other protocols. Each network card 120 may support a single communications protocol, may support a number of related protocols, or may support a number or combination of unrelated protocols.

The term “network card” as used herein encompasses line cards, test cards, analysis cards, network line cards, load modules, interface cards, network interface cards, data interface cards, packet engine cards, service cards, smart cards, switch cards, relay access cards, CPU cards, port cards, and others. The network cards 120 may be referred to as blades, particularly when a processor is included on the network card.

The network cards 120 may include one or more processors 124 and one or more network communications units 128. In another embodiment, the network cards 120 may have no processors 124 and may include one or more network communications units 128. In the embodiment in which the network cards do not include a processor, processing may be performed by a processor on a motherboard of the network testing system 110, on another card, on the backplane or by a remote or external unit. When the network card 120 includes two or more network communications units 128, the network card 120 is in effect two or more network capable devices. That is, a network card 120 having n network communications units 128 may function as n network capable devices.

The network communications unit 128 may be implemented as one or more field programmable gate arrays (FPGA), application specific integrated circuits (ASIC), programmable logic devices (PLD), programmable logic arrays (PLA), other kinds of devices, and combinations of these. The network communications unit 128 may support one or more communications protocols. The network communications unit 128 may include a network interface through which the network card 120 may transmit and/or receive communications over the network 140.

The back plane 112 may serve as a bus or communications medium for the network cards 120. The back plane 112 may also provide power to the network cards 120. The back plane 112 may provide a current time to the network cards 120. In the first embodiment, the back plane 112 includes a clock or time generating chip or circuit that serves as a system clock for the network testing system 110. In this embodiment, each of the network cards 120 may obtain a system time from the system clock available on the backplane.

The network testing system 110 may have a computer (not shown) coupled thereto. The computer may be local to or remote from the network testing system 110. In another embodiment, the network testing system 110 may include a CPU on a card, motherboard or backplane that allows the chassis to also serve as a computer workstation. In one embodiment, a system mother board may include a chip or circuits to maintain a system clock. In this embodiment, the network cards 120 may access the system motherboard to obtain a current time for the network testing system 110. In this way, the network cards 120 may each keep a local time synchronized with a system clock maintained by the mother board of network testing system 110.

The network testing system 110 may have coupled therewith a display 118 and user input devices such as a keyboard 114 and a mouse 116, as well as other user input devices including, for example, pens and trackballs. The user input devices may be coupled to a network card, other card, motherboard, or backplane included in the chassis.

The network testing system 110 may be implemented in a computer such as a personal computer, server, or workstation, as well as the chassis shown. The network testing system 110 may be used alone or in conjunction with one or more other network testing systems 110. The network testing system 110 may be located physically adjacent to and/or remote to the network capable devices 130 and time server 133 in the network 140. The network testing system 110 may be used to test and evaluate the network 140 and/or portions thereof, network capable devices 130, applications running on network capable devices 130, and/or services provided by network 140 and/or network capable devices 130 and/or network applications. The network testing system 110, the network cards 120, and the network communications units 128 may all be network capable devices.

The network 140 may be a local area network (LAN), a wide area network (WAN), a storage area network (SAN), or a combination of these. The network 140 may be wired, wireless, or a combination of these. The network 140 may include or be the Internet. The network 140 may be public or private, may be a segregated test network, and may be a combination of these. The network 140 may be comprised of a single or numerous nodes providing numerous physical and logical paths for data units to travel. Each node may be a network capable device as described below. A node may be a computing device, a data communications device, a network capable device, a network card, or other devices as defined and described herein.

Communications on the network 140 may take various forms, including frames, cells, datagrams, packets, higher level logical groupings, or other units of information, all of which are referred to herein as data units. Those data units that are communicated over a network are referred to herein as network traffic. The network traffic may include data units that represent electronic mail messages, streaming media such as music (audio) and video, telephone (voice) conversations, web pages, graphics, documents, and others.

The network capable devices 130 may be devices capable of communicating over the network 140 and/or listening to, injecting, delaying, dropping, relaying, processing, and/or modifying network traffic on network 140. The network capable devices 130 may be computing devices such as computer workstations, personal computers, servers, portable computers, set-top boxes, video game systems, personal video recorders, telephones, personal digital assistants (PDAs), computing tablets, and the like; peripheral devices such as printers, scanners, facsimile machines and the like; network capable storage devices including disk drives such as network attached storage (NAS) and SAN devices; testing equipment such as network analyzing devices, network conformance systems, emulation systems, network monitoring devices, and network traffic generators; components such as processors, network cards and network communications units; and networking devices such as routers, relays, firewalls, hubs, switches, bridges, traffic accelerators, and multiplexers. In addition, the network capable devices 130 may include appliances such as refrigerators, washing machines, and the like as well as residential or commercial heating, ventilation, and air conditioning (HVAC) systems, alarm systems, and other devices or systems capable of communicating over a network.

One or more of the network capable devices 130 may be devices to be tested and may be referred to as devices under test. The delay measuring described herein may be implemented to measure or learn the delay in one or more devices under test in network 140 or a network segment. The delay measuring described herein is particularly useful when the device under test is a router, switch, intermediary server, or other network communications device.

Time server 133 is a server computer or group of computing devices that provide a universally recognized time upon receipt of a request for the current time. The time server 133 may conform to the Network Time Protocol (NTP) standard set forth in RFC 1305 (D. Mills, March 1992) or its progeny. In a second embodiment, the network testing system 110 and the network cards therein may obtain the current time from the time server 133. In the second embodiment, the network testing system 110 may include an NTP component or client that is synchronized with a remote NTP server, namely time server 133.

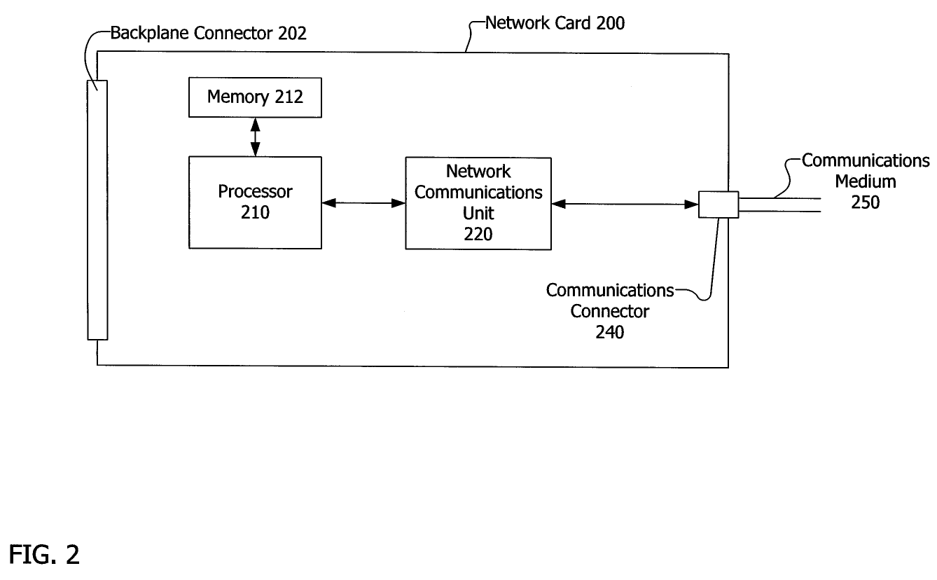

FIG. 2 is a block diagram of a network card in which measuring delay may be implemented. The network card 200 may include hardware, software, firmware, and/or a combination thereof. The network card may include a processor 210, a network communications unit 220, a memory unit 212, a backplane connector 202, and a communications connector 240. In another embodiment, there are no processors 210 in the network card 200. The memory 212 and network communications unit may all be included in a single PLD or FPGA. The network card 200 may have one or more network communications units 220 and a corresponding number communications connectors 240. The network card 200 may also have one or more memory units 212 and one or more processors 210 included thereon. The network card 200 may include an operating system or a real-time operating system.

The backplane connector 202 may allow the network card 200 to be coupled with a network testing system such as networking testing system 110. The memory 212 may be, for example, random access memory (RAM), and may be coupled with processor 210. The processor 210 may be a multipurpose processor, such as, for example, a PowerPC processor available from IBM, Inc., and may be a specialized processor. The processor 210 may be coupled with the network communications unit 220. The processor is capable of executing instructions which may be located in a local memory, other storage medium, or other local or remote storage device. In one embodiment, the network card 200 includes no processor, and commands are received from a processor included on another card, on a mother board, or on the backplane.

The network card 200 may keep a local time in software, hardware and/or firmware. The network card 200 may include a local clock chip or circuit and/or local clock software to keep an accurate time based on a time received from, in the first embodiment, the back plane or, in the second embodiment, from a remote time server. The network card 200 may also obtain a time from a motherboard of a network testing system in which the network card is coupled.

The network card 200 may include and/or have access to local and/or remote memory, storage media and storage devices. Instructions to be executed by the processor may be stored on and executed from a local or remote machine readable medium or storage device. A machine readable medium includes, for example, without limitation, magnetic media (e.g., hard disks, tape, floppy disks), optical media (e.g., CD, DVD), flash memory products (e.g., memory stick, compact flash and others), and volatile and non-volatile silicon memory products (e.g., random access memory (RAM), programmable read-only memory (PROM), electronically erasable programmable read-only memory (EEPROM), and others). A storage device is a device that allows for the reading from and/or writing to a machine readable medium. Storage devices include hard disk drives, solid-state drives (SSDs), DVD drives, flash memory devices, and others.

Additional and fewer units, hardware and firmware may be included in the network card 200.

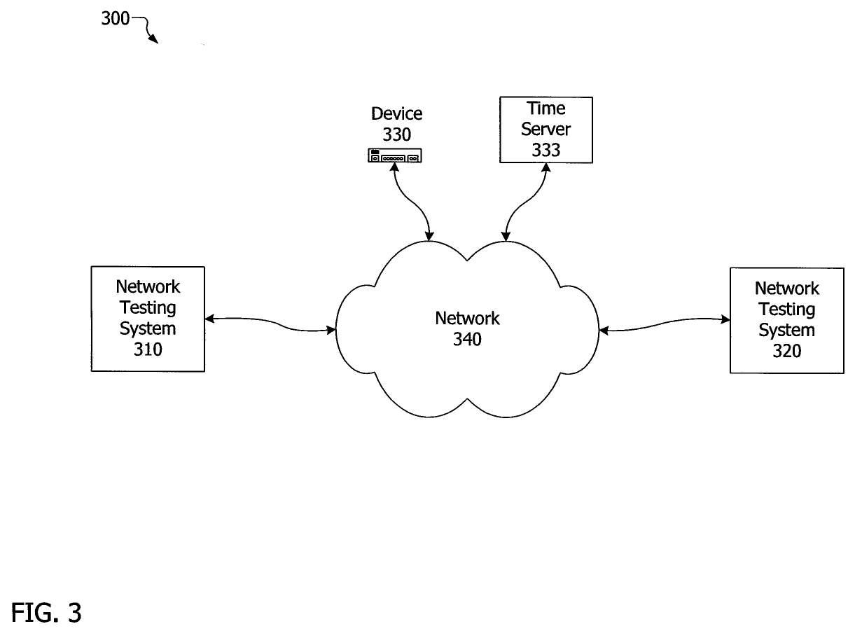

FIG. 3 is a block diagram of a second environment in which measuring delay may be implemented. The second environment 300 shows the second embodiment of the systems and methods for measuring delay described herein. The second environment 300 includes network testing systems 310 and 320, a network communications device 330 and a time server 333 all coupled with network 340. The network testing systems 310 and 320 are like the network testing system 110 shown and described regarding FIG. 1. The network 340 is like the network 140 described above regarding FIG. 1. The time server 333 is like the time server 133 described above regarding FIG. 1. The time server 333 may conform to the NTP standard, and each of the network testing systems 310 and 320 may include a component or client that is synchronized with the remote time server 333. The network communications device 330 is typically a router, switch, intermediary server and may be other network capable devices.

When sending data units over a network through another device such as a router, a switch, an intermediary server, or over a network segment, delay is typically introduced. The delay may be introduced into data units during processing performed by the router, switch, intermediary server or other network communications device, or may be introduced by the kind of communication medium used.

Network communications device introduced delay and/or network segment introduced delay may be measured according to the methods of measuring delay described herein. The measurements resulting from the methods described herein are particularly suited to evaluating networks and network communications devices involved with the transmission of streaming media, streaming music (audio), streaming video, and voice communications traffic, such as, for example, voice over the Internet Protocol (VOIP). The delay measurements may be used to assist in the computation of quality of service scores including, for example, VOIP MOS scores such as Perceptual Evaluation of Audio Quality(PEAQ), Perceptual Analysis Measurement System (PAMS), Perceptual Evaluation of Speech Quality (PESQ) score and Perceptual Speech Quality Measure (PSQM) score, video MOS scores such as Perceptual Evaluation of Video Quality (PEVQ) score, and other video transmission, streaming media, streaming audio, and real-time communications quality measurements.

A Packet

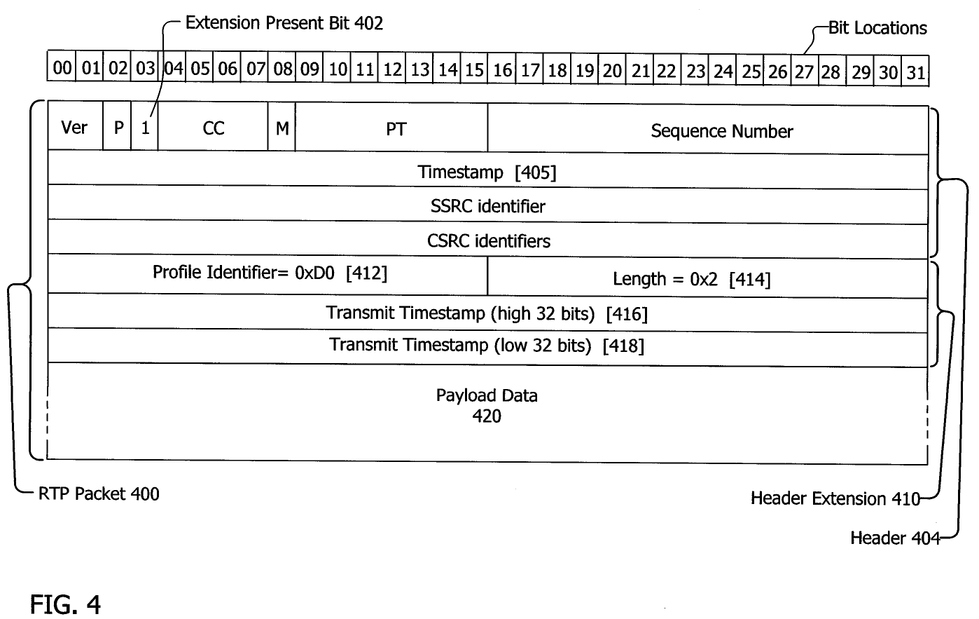

FIG. 4 is a diagram of a packet used in measuring delay. The methods described herein include adding a time to an extended header in an RTP packet. The RTP packet conforms to the RTP standard set forth in RFC 3550 (H. Schulzrinne et al., July 2003) and its progeny. RTP packet fields not discussed herein are set forth in RFC 3550.

According to the RTP standard, when the extension bit, referred to as bit X at bit 03, of an RTP packet is set, the fixed header 404 is followed by a header extension 410. As shown in FIG. 4, the extension present bit 402 is set in RTP packet 400, signifying that header extension 410 follows the traditional header 404. The header extension 410 includes 32 bits of a header extension header that is broken into two 16 bit fields. The header extension header includes a 16 bit profile identifier value and a 16 bit length. The profile identifier value 412, as used herein, identifies the header extension timestamp storage techniques described herein. That is, profile value 412 is set to identify the header extension as conforming to the methods described herein and including a timestamp in the header extension data area. In one embodiment, the profile identifier value is set to be 0xD0 to identify the header extension as conforming to the methods used herein. The profile identifier value 412 may be a different 16 bit value that is recognized by the network testing system or other implementer of the methods described herein.

As defined by the RTP standard, after the 16 bit profile identifier value 412, the header extension 410 contains a 16 bit length field 414 that provides the number of 32-bit words in the header extension (excluding the 32 bit extension header). In the example shown, length 414 is set to 0x2 as the representation of time used herein is two 32 bit words. The time is stored as transmit timestamp high 32 bits 416 and transmit timestamp low 32 bits 418.

The transmit timestamp used according to the methods described herein differs from the timestamp 405 included in the RTP header. The timestamp 405 included in the RTP header is often based on a sampling clock used to synchronize a real time media stream contained in the payloads of multiple RTP packets. When a payload includes stored data rather than real time media, the timestamp 405 may be the presentation time for the data stored in the payload. The uses of timestamp 405 are set forth in the RTP standard. In various uses of RTP packets, the timestamp 405 cannot be used in computing a transmission delay because the timestamp may be used to synchronize packets in a real-time stream and may not contain a true time. Further, the timestamp 405 may be the time from the local clock on the sender network testing system or sender network card which is not synchronized with the clock on a recipient network testing system or recipient network card. As stated in the RTP standard (RFC 355), “RTP timestamps from different media streams may advance at different rates and usually have independent, random offsets. Therefore, although these timestamps are sufficient to reconstruct the timing of a single stream, directly comparing RTP timestamps from different media is not effective for synchronization.”

In the second embodiment, a global, well known, synchronized time from a time server such as, for example, an NTP server, may be obtained from a local NTP client or component that is synchronized with a remote NTP time server according to the methods described in the NTP specification, or direct communication with an NTP server may be performed. Using an NTP client or component or communicating with an NTP server directly overcomes the time discrepancies inherent in using local clock times when two or more network testing systems are involved.

In the first embodiment, each of the network cards may obtain a system time from a clock included with the back plane of a network testing system. In this way, each of the network cards in a network testing system may be synchronized and have access to a well known, consistent clock. That is, in the first embodiment, each of the network cards may have the same time and the time on each of the network cards may be synchronized with the back plane of the network testing system in which the cards are included. In another embodiment, the network cards may access a system mother board to obtain a current time. In this way, the network cards may keep a local time synchronized with a time obtained from a mother board of a network testing system.

The header extension 410 is followed by payload data 420. Payload data 420 is the content of the RTP packet, typically, a portion of data used in a streaming media application such as an audio stream or video stream, including a voice or video telephone call. The payload data 420 may be obtained from and provided by a program running on the network testing system or network card, or, more specifically, from a processor executing a program on the network card or on the network testing system.

The organization of the RTP packet 400 supports the techniques for storing a transmit time without altering either the content of the RTP header 404 or the payload data 420 included in the RTP packet.

The Methods

The methods described herein may be implemented in various environments, including environments 100 and 300 shown in FIGS. 1 and 3.

As shown in FIG. 1, to perform various tests, the network testing system 110 may send data units from a first network card 120 to a second network card through an intermediary network communications device such as a router, switch, intermediary server or other network capable device 130 over network 140.

As shown in FIG. 3, to perform various tests, the first network testing system 310 may send data units to a second network testing system 320 through an intermediary network communications device 330 such as a router, switch, intermediary server or other network communications device over network 340.

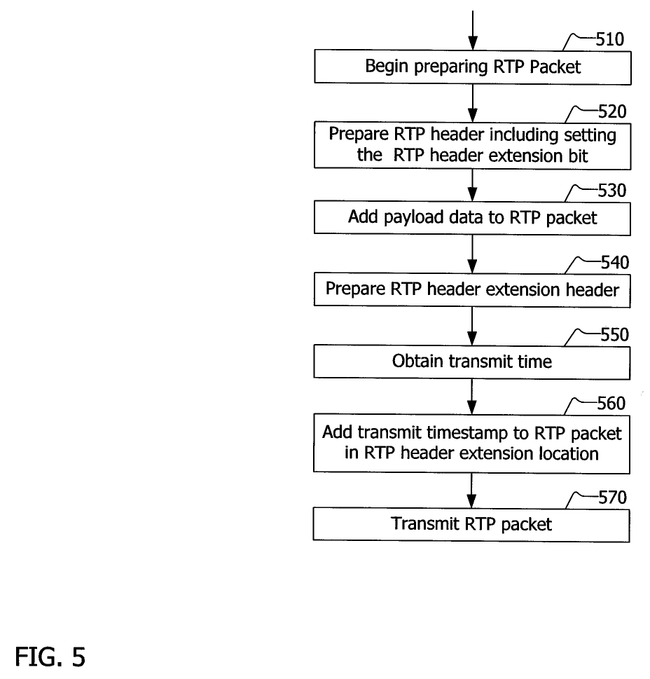

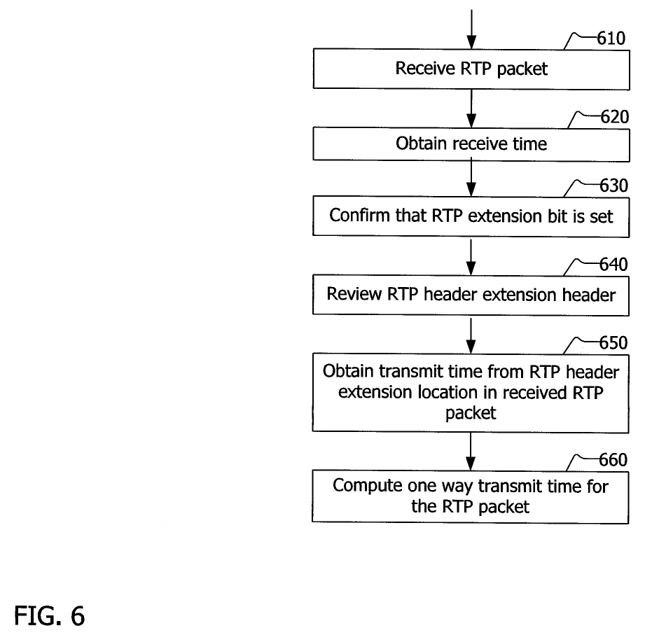

The methods described below in FIGS. 5 and 6 may be implemented on one or more FPGAs and/or other hardware devices, such as, for example, digital logic devices. The methods described below in FIGS. 5 and 6 may be implemented as software that is executed by a processor, including a processor on a network card or a processor in a blade or other card with a processor. The software may be stored on a volatile or nonvolatile memory device or storage medium include in or on and/or coupled with a computing device, a network card, or other card. The methods may be implemented in the first embodiment by two network cards 120 in a single network testing system shown in FIG. 1 or may be implemented in the second embodiment between two network testing systems 310 and 320 shown in FIG. 3.

FIG. 5 is a flow chart of actions taken by a sender of a data unit implementing a method of measuring delay. The sender may be a first network card 120 of network testing system 110 shown in FIG. 1 according to the first embodiment, or may be the first network testing system 310 shown in FIG. 3 according to the second embodiment.

The sender begins preparing an RTP packet, as shown in block 510. The sender prepares the RTP header, including setting the RTP header extension bit in the RTP packet, as shown in block 520. The source of the RTP packet may be a network testing system, and the destination of the packet may be the same or another network testing system. The source of the RTP packet may be a first network card in a network testing system, and the destination of the packet may be a second network card in the same network testing system. The sender adds payload data to the RTP packet, as shown in block 530. The source of the payload data included in the RTP packet may be a network testing system, and more specifically, a network testing software program include in the network testing system.

The sender prepares the RTP header extension header which includes filling out the first 32 bits of the RTP header extension area, as shown in block 540. The first 32 bits are a 16 bit profile identifier value and a 16 bit length value shown as 412 and 414 in FIG. 4 and described above. The payload data of the RTP packet may be added to the RTP packet.

The sender obtains the current time, as shown in block 550. The time may be obtained from a local time server client or component that obtains the time from and is synchronized with, in the first embodiment, a backplane of the network testing system or, in the second embodiment, a remote time server. The synchronization in the second embodiment may be achieved according to the NTP standard. In another embodiment, the time may be based on or obtained from a local client or component that is synchronized with the mother board of a network testing system.

According to these methods, the time representing the time of transmission for the outgoing data unit is obtained immediately or nearly immediately after any initial processing performed concerning the outgoing RTP packet and as close as practicable in time to transmitting the outgoing RTP packet. The sender adds the obtained time as a transmit timestamp to the RTP header extension location in the RTP packet, as shown in block 560. The transmit timestamp is shown as transmit timestamp 416 and 418 of FIG. 4 and described above. The sender then transmits the RTP packet to a destination, as shown in block 570. The RTP packet is sent to the destination through a network communications device and/or over a network segment. In this way, the transmit time is stored in the RTP packet without altering either the content of the RTP header 404 or the payload data 420 included in the RTP packet.

FIG. 6 is a flow chart of actions taken by a recipient of a packet implementing a method of measuring delay. The recipient may be, in the first embodiment, a second network card 120 of network testing system 120 shown in FIG. 1 or may be, in the second embodiment, the second network testing system 320 shown in FIG. 3.

The recipient receives an RTP packet, as shown in block 610. The recipient obtains a receive time, as shown in block 620. In the first embodiment, the receive time may be obtained from a local time client on the network card. The local time client obtains and maintains a local time that is synchronized with the system time maintained on the back plane of the network testing system. In another embodiment, the network cards may access a system mother board to obtain a current system time. In this way, the network cards may keep a local time synchronized with a system clock maintained by the system mother board.

In the second embodiment, the receive time is based on a time synchronized with a remote time server. In the second embodiment, the time may be obtained from a local time server client or component that is synchronized with a remote time server. The remote time server may be the same remote time server used by the sender, or it may be a different time server. When the time server used by the recipient is different, the recipient accessed time server must be synchronized with the time server accessed by the sender. This synchronization may be achieved according the NTP standard.

The recipient obtains the transmit time from the received RTP packet. Specifically, the recipient confirms that the RTP header extension bit is set, as shown in block 630. Because the extension bit in the RTP packet header is set, the recipient examines the RTP header extension area located after the header (see 410 of FIG. 4), as shown in block 640. In this examination, the recipient confirms the profile identifier value (see 412 of FIG. 4) to ensure that the packet conforms to the methods described herein. This may be achieved by a simple value matching or comparison with a system defined value the represents that the packet was prepared according to the methods described herein. As part of reviewing the RTP header extension header, the recipient obtains or extracts the size of the time data or confirms the size of the time data shown as 414 in FIG. 4. The size of the time data is, in one embodiment, 64 bits or two 32 bit words. In other embodiments, the time data may be 32 bits, 48 bits, 128 bits, 256 bits or other size. The recipient obtains or extracts the transmit time (see 416 and 418 in FIG. 4) from the header extension location in the received RTP packet, as shown in block 650. The recipient then computes the one way transmit time for the received RTP packet, as shown in block 660. This computation is achieved by evaluating the difference between the receive time obtained from, in various embodiments, the remote time server, the local time server client, or the system time, and the transmit time obtained from the RTP packet. In one embodiment, the one way delay may be computed by subtracting the transmit time from the receive time.

The recipient network card or network testing system may use the computed transmit time values to evaluate the performance of a network communications device or network segment. The transmit time may be the one way delay of communication over a network segment or through an intermediary network communications device. The delay values obtained according to this method may be aggregated to determine an average, typical or other delay incurred when communicating through or over a network communications device under test, a network communications device on a live, in service network, and/or over a network segment. The delay values may be used in computing a Mean Opinion Score (MOS) or R-value score of voice transmission over a network or portion thereof, including VOIP, a video quality score or rating, a broadband quality score, or other similar media transmission score over or through a network communications device and/or a network segment. The delay values may be used in computing scores according to the International Telecommunication Union (ITU) E-model Recommendation ITU-T Rec. G.107. Other analysis and evaluation of network traffic, network applications, and network capable devices may be performed using the time stamping described herein.

With regard to FIGS. 5 and 6, additional and fewer steps may be taken, and the steps as shown may be combined or further refined to achieve the methods described herein.

Although exemplary embodiments of the invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

It is claimed:

1. A method of computing a delay comprising:
a source receiving an outgoing data unit from a processor, the outgoing data unit intended for a destination;
the source preparing a real-time transport protocol (RTP) packet to transmit the outgoing data unit, the preparing including
setting a header extension bit of the RTP packet,
preparing a header extension header of the RTP packet,
obtaining a transmit time,
adding the transmit time as a time stamp to the header extension area of the RTP packet
the source transmitting the RTP packet to the destination
the destination receiving the RTP packet
the destination obtaining a receive time
the destination processing the RTP packet, the processing including
confirming that the RTP header extension bit is set,
confirming that a profile identifier data in the RTP header extension header matches a system defined identifier,
confirming a length of the RTP header extension,
extracting the transmit timestamp from the RTP header
the destination computing a one way delay for the RTP packet to travel from the source to the destination.

2. The method of claim 1 wherein the source and the destination are each a network card include in a network testing system.

3. The method of claim 2 wherein the transmit time and the receive time are based on a system time obtained from a back plane of the network testing system

4. The method of claim 2 wherein the transmit time and the receive time are based on a system time obtained from a mother board of the network testing system

5. The method of claim 1 wherein the source and the destination are different network testing systems.

6. The method of claim 5 wherein the transmit time and the receive time are based on a remote time obtained from a remote time server.

7. The method of claim 6 wherein the remote time server conforms to a Network Time Protocol standard.

8. The method of claim 1 wherein the transmit time is based on a first remote time obtained from a first time server and the receive time is based on a second remote time obtained from a second remote time server.

9. The method of claim 8 wherein the first remote time server and the second remote time server are different time servers.

10. A system for computing a delay comprising:
a source network testing system configured to perform actions including receiving an outgoing data unit from a processor, the outgoing data unit intended for a destination network testing system;
preparing a real-time transport protocol (RTP) packet to transmit the outgoing data unit, the preparing including
setting a header extension bit of the RTP packet,
preparing a header extension header of the RTP packet,
obtaining a transmit time,
adding the transmit time as a time stamp to a header extension area of the RTP packet
transmitting the RTP packet to the destination network testing system the destination network testing system configured to perform actions including
receiving the RTP packet
obtaining a receive time
processing the RTP packet, the processing including
confirming that the RTP header extension bit is set,
confirming a profile identifier data in the RTP header extension header matches a system defined identifier,
confirming a length of the RTP header extension,
extracting the transmit timestamp from the RTP header
computing a one way delay for the RTP packet to travel from the source network testing system to the destination network testing system.

11. The system of claim 10
wherein the source network testing system and the destination network testing system are a single network testing system
wherein the single network testing system includes a first network card and a second network card
wherein that the first network card performs the actions of the source network testing system and the second network card performs the actions of the destination network testing system.

12. The system of claim 11 wherein the transmit time and the receive time are based on a system time obtained from a back plane of the single network testing system.

13. The system of claim 11 wherein the transmit time and the receive time are based on a system time obtained from a motherboard of the single network testing system

14. The system of claim 10 wherein the source network testing system and the destination network testing system are different network testing systems.

15. The system of claim 14 wherein the transmit time and the receive time are based on a first remote time and a second remote time each obtained from a remote time server.

16. The system of claim 15 wherein the remote time server conforms to a Network Time Protocol standard.

17. The system of claim 14 wherein the transmit time is based on a first time obtained from a first remote time server and the receive time is based on a second time obtained from a second remote time server.

18. The system of claim 17 wherein the first remote time server and the second remote time server conform to a Network Time Protocol standard.
